(19) United States
(12) Patent Application Publication
(10) Pub. No.: US 2024/0421330 A1
(43) Pub. Date: Dec. 19, 2024

(54) THROTTLE FLAP ACTUATOR UNIT, FUEL CELL SYSTEM HAVING A THROTTLE FLAP ACTUATOR UNIT OF SAID TYPE, AND MOTOR VEHICLE HAVING A FUEL CELL SYSTEM OF SAID TYPE

(71) Applicant: Vitesco Technologies GmbH, Regensburg (DE)

(72) Inventors: Alexandru POPA, Timisoara (RO); Alexandru-llie ISAINCU, Dudestii Noi (RO); Mihai DRIENOVSKY, Timisoara (RO)

(21) Appl. No.: 18/704,589

(22) PCT Filed: Oct. 14, 2022
(86) PCT No.: PCT/EP2022/078701

§ 371 Date: Apr. 25, 2024

(30) Foreign Application Priority Data
Oct. 26, 2021 (EP) 21465555.7
Oct. 28, 2021 (DE) 10 2021 212 202.7

(51) Int. Cl. H01M 8/04089; H01M 8/04082

(52) U.S. Cl. CPC H01M 8/04089; H01M 8/04201; H01M 2250/20

(57) ABSTRACT

A throttle flap actuator unit having a throttle flap actuator having an electric-motor-adjustable throttle flap, and a fluid channel, the fluid channel having a first and a second fluid channel section, the first fluid channel section having a flow cross section which is variable by the throttle flap. The second fluid channel section has a geometry which gives rise to a pressure drop in a fluid flowing through the fluid channel. A fuel cell system has a throttle flap actuator unit of this type and motor vehicle has a fuel cell system of this type.

### CROSS REFERENCE TO RELATED APPLICATIONS

This is a U.S. national stage of Application No. PCT/EP2022/078701 filed Oct. 14, 2022. Priority is claimed on European Application No. EP 21465555.7 filed Oct. 26, 2021 and German Application No. DE 10 2021 212 202.7 filed Oct. 28, 2021, the content of which is incorporated herein by reference.

### BACKGROUND OF THE INVENTION

### 1. Field of the Invention

The disclosure relates to a throttle flap actuator unit, a fuel cell system having a throttle flap actuator unit of this type, and a motor vehicle having a fuel cell system of this type.

### 2. Description of the Related Art

In fuel cell systems of motor vehicles, throttle flap actuators are used to control the feed of air to the fuel cell stack of the fuel cell system. For this purpose, a first fluid channel leads into the fuel cell stack, whereas a second fluid channel leads out of the fuel cell stack. Here, it has become established in the prior art to arrange a first throttle flap actuator at the air inlet side and to arrange a second and a third throttle flap actuator in series with respect to one another at the air outlet side. Whilst the second throttle flap actuator is designed to open or close the second fluid channel, the third throttle flap actuator is designed to set the desired pressure in the second fluid channel. It would be desirable to combine the functions of the second and of the third throttle flap actuator in a single throttle flap actuator in order to achieve a cost saving. However, the demands on the second and third throttle flap actuators are contradictory. Whilst the second throttle flap actuator is designed to set as exact a pressure as possible in a manner dependent on the rotational angle position of the throttle flap of the second throttle flap actuator, the third throttle flap actuator is designed to, in the closed position of the throttle flap, close the second fluid channel as tightly as possible and, in the open position, provide the least possible pressure loss.
Document DE 10 2010 051 429 A1 relates to a throttle flap actuator.

### SUMMARY OF THE INVENTION

It is an object of the present invention to create a throttle flap actuator unit which, on the one hand, allows the most exact possible control of the pressure and, on the other hand, makes possible the least possible pressure loss in the open position of the throttle flap and the greatest possible sealing action in the closed position of the throttle flap. Furthermore, a second object of the present invention consists in providing a fuel cell system having a throttle flap actuator unit of said type. Furthermore, a third object consists in providing a motor vehicle having a fuel cell system of said type.

One aspect of the invention is a throttle flap actuator unit having a throttle flap actuator, which has an electric-motor-adjustable throttle flap, and having a fluid channel, the fluid channel having a first and a second fluid channel section, the first fluid channel section comprising a flow cross section which is variable by means of the throttle flap, the second fluid channel section having a geometry which gives rise to a pressure drop in a fluid flowing through the fluid channel.

By the throttle flap actuator unit according to one aspect of the invention, it is possible for only this single throttle flap actuator unit to be arranged at the air outlet side with respect to a fuel cell stack, and for costs for a further throttle flap actuator, which would otherwise have to be arranged at the air outlet side in series with respect to another throttle flap actuator, to thus be saved. In other words, it is ensured by the throttle flap actuator unit that, in a closed position of the throttle flap of the throttle flap actuator of the throttle flap actuator unit, the fluid channel is closed in the most fluid-tight manner possible, whereas, in an open position of the throttle flap of the throttle flap actuator of the throttle flap actuator unit, the least possible pressure losses arise. At the same time, with the throttle flap actuator unit according to one aspect of the invention, owing to the geometry of the second fluid channel section, in particular in the case of small flow cross sections or small opening angles of the throttle flap, it is possible for the pressure in the fluid channel to be set as exactly as possible because, owing to the geometry of the second fluid channel section, a greater movement of the throttle flap is required for a certain pressure difference than would be necessary without this geometry.

In a further preferred aspect of the invention, the geometry of the second fluid channel section is configured such that, in the case of an opening movement of the throttle flap of less than 30° in relation to a position in which the throttle flap closes the variable flow cross section, only a disproportionately small pressure increase can be generated downstream of the throttle flap. The attribute “disproportionately small” is in particular in relation to a pressure increase that can be generated by an opening movement of the throttle flap of greater than 30° in relation to a position in which the throttle flap closes the variable flow cross section. Alternatively, the geometry of the second fluid channel section is configured such that, in the case of an opening movement of the throttle flap up to a flow cross section that corresponds to 20% of the maximum variable flow cross section, only a disproportionately small pressure increase can be generated downstream of the throttle flap. The attribute “disproportionately small” is in particular in relation to a pressure increase that can be generated downstream of the throttle flap in the case of a flow cross section that corresponds to 50% to 100% of the maximum variable flow cross section.

The throttle flap actuator unit and/or the throttle flap actuator is preferably a throttle flap actuator unit or a throttle flap actuator for a fuel cell system. In other words, the throttle flap actuator unit or the throttle flap actuator is in this case designed in accordance with its field of use and suitable for this intended use. In this way, the throttle flap actuator unit and the throttle flap actuator can be optimized with regard to suitability and service life for use in a fuel cell system.

It is particularly advantageous if the throttle flap actuator has a throttle flap actuator housing which comprises the first and/or the second fluid channel section. It is particularly preferable if the throttle flap actuator housing is formed as a single piece with the first and/or the second fluid channel section. In this way, a separate manufacturing process can be omitted, which saves costs. At the same time, an assembly process and a separate connection between the throttle flap actuator housing and one of the fluid channel sections can be omitted, which saves further costs. Furthermore, owing to the joint form, for example owing to a plastics injection molding or a metal casting process, the most exact possible alignment between the throttle flap actuator and the fluid channel sections is possible.

It is also advantageous if the throttle flap actuator comprises an electric motor by which the throttle flap is adjustable. The electric motor is preferably configured as a mechanically commutated direct-current motor or as a permanently excited synchronous motor. Whereas the former type of motor is highly cost-effective, the latter type of motor is extremely durable. It is furthermore also conceivable for a stepper motor to be used as an electric motor in order to adjust the throttle flap of the throttle flap actuator. In this way, a detector for detecting the position of the throttle flap can be omitted, which saves further costs.

It is also preferred if the variability of the flow cross section of the first fluid channel section is dependent on the situation of the throttle flap in the first fluid channel section.

It is furthermore preferred if the throttle flap actuator comprises a shaft via which the electric motor of the throttle flap actuator varies the situation of the throttle flap in the first fluid channel section. For this purpose, the shaft is connected rotationally conjointly to the throttle flap. It is possible here for the shaft to exit the first fluid channel section at one or at two points. This means that the shaft penetrates radially through the channel wall of the first fluid channel section, which channel wall delimits the first fluid channel section. Such a penetration is also referred to in the context of the invention as an exit point of the shaft.

In a preferred variant, in which the shaft exits the first fluid channel section at two locations, a first exit point of the shaft from the first fluid channel section serves for the drive-transmitting connection of the throttle flap to the electric motor of the throttle flap actuator. In particular, this first exit point of the shaft from the first fluid channel section may additionally serve for the mounting of the shaft and/or of the throttle flap. In particular, the second exit point of the shaft from the first fluid channel section serves only for the mounting of the shaft and/or of the throttle flap.

In a further aspect of the invention, the first fluid channel section has only one exit point of the shaft. In other words, this exit point of the shaft serves both for the mounting of the shaft and/or of the throttle flap and for the drive-transmitting connection of the throttle flap to the electric motor of the throttle flap actuator.

In one aspect of the invention, an exit point of the shaft, or the first and the second exit points of the shaft, is/are situated in the plane that is closed by the throttle flap in its closed position. This constitutes a particularly simple configuration of a mounting of the shaft and of the throttle flap.

In one aspect of the invention, an exit point of the shaft is situated, as viewed in a flow direction, in front of or behind in the plane that is closed by the throttle flap in its closed position. This prevents the exit point of the shaft from the first fluid channel section from giving rise to an undesired bypass volume flow. In the event that two exit points of the shaft from the first fluid channel section are provided, it is possible for the two exit points of the shaft to be situated spaced apart from the plane that is closed by the throttle flap in its closed position. In other words, it is possible for both exit points of the shaft to be situated, as viewed in the flow direction, in front of or behind the plane. It is also possible for in each case one exit point of the shaft to be situated in front of and behind the plane. Undesired bypass volume flows past the plane that is closed by the throttle flap in its closed position, which bypass volume flows are caused by the required gap dimensions of the exit points of the shaft, are hereby prevented.

In the context of one aspect of this invention, a closed position of the throttle flap of the throttle flap actuator is to be understood to mean a position of the throttle flap in which the flow cross section of the first fluid channel section is at a minimum. This is not necessarily to be understood to mean that the throttle flap closes the first fluid channel in absolutely fluid-tight fashion. In other words, it is possible that a desired or undesired bypass volume flow of the flowing fluid occurs, which in the case of an undesired bypass volume flow lies within a range of acceptable for the usage situation. The open position of the throttle flap is to be understood in the context of this invention to mean that the throttle flap is situated in a position in which the flow cross section of the first fluid channel section is at a maximum.

The flowing fluid is preferably air. In particular, it is a conveyable fluid or air stream. For the conveyance of the air stream, it is for example conceivable to use an electric-motor-driven radial compressor. In this way, a continuous air stream can be provided which is distinguished by negligibly small pulsations.

A preferred aspect of the invention is characterized in that the second fluid channel section is arranged spaced apart from the flow cross section of the first fluid channel section. In other words, the geometry which gives rise to a pressure drop of a fluid flowing through the fluid channel is not integrated into the flow cross section, which is variable by means of the throttle flap, of the first fluid channel section. In this way, it is possible for the first fluid channel section to be formed independently of the second fluid channel section. Preferably, the first fluid channel section is of flow-optimized form, that is to say configured such that the least possible pressure losses arise.

One aspect of the invention is characterized in that the second fluid channel section is arranged upstream or downstream of the first fluid channel section. “Upstream” refers to a direction counter to the flow direction of the flowing fluid, whereas “downstream” refers to a direction in the direction of the flow direction of the flowing fluid. In particular as a result of the arrangement of the second fluid channel section downstream of the first fluid channel section, a large pressure drop is generated for small opening angles of the throttle flap, that is to say for small flow cross sections, which ensures that precise pressure control is possible in the case of small opening angles of the throttle flap.

A further aspect of the invention is characterized in that the geometry of the second fluid channel section has at least two flow cross sections. It is particularly advantageous if the geometry of the second fluid channel section transitions, in the flow direction of the flowing fluid, from a first flow cross section of the second fluid channel section into a second flow cross section of the second fluid channel section. It is particularly advantageous here if the second flow cross section of the second fluid channel section is smaller than the first flow cross section of the second fluid channel section.

In one aspect of the invention, the geometry of the second fluid channel section has at least one third flow cross section. This third flow cross section advantageously directly adjoins the second flow cross section in the flow direction. Furthermore, it is preferred if the third flow cross section is larger than the second flow cross section. It is furthermore highly preferred if the third flow cross section corresponds to the first flow cross section.

In a further aspect of the invention, a transition from the first flow cross section of the second fluid channel section to the second flow cross section of the second fluid channel section and/or from the second flow cross section of the second fluid channel section to the third flow cross section of the second fluid channel section is formed as an abrupt, that is to say discontinuous, change in flow cross section. This change in flow cross section is in relation to the flow direction of the fluid.

A further aspect of the invention is characterized in that the second flow cross section of the second fluid channel section is formed by a ring pressed into the second fluid channel section. In other words, the inner diameter of the ring defines the second flow cross section of the second fluid channel section, whereas the outer diameter of the ring is selected such that, when the ring is pressed into the second fluid channel section, said outer diameter gives rise to an interference fit between the ring and the second fluid channel section. This is a particularly inexpensive and simple means of forming the geometry of the second fluid channel section.

A further aspect of the invention is characterized in that the geometry of the second fluid channel section corresponds to the geometry of a throttle or an aperture. In other words, the geometry of the second fluid channel section corresponds, in the case of a throttle, to a geometry in which the second flow cross section of the second fluid channel section is smaller than the first flow cross section of the second fluid channel section, and the second flow cross section extends over a length in the flow direction of the fluid which is greater than a or the diameter of the second flow cross section of the second fluid channel section.

In the case of an aperture, the geometry of the second fluid channel section corresponds to a geometry in which the second flow cross section of the second fluid channel section is smaller than the first flow cross section of the second fluid channel section, and the second flow cross section extends over a length in the flow direction of the fluid which is smaller than a or the diameter of the second flow cross section of the second fluid channel section. If the second flow cross section of the second fluid channel section has a circular geometry, in other words has only one diameter, which is preferred, then this diameter is to be used for the above comparison or the above embodiments that relate to the aperture and the throttle. In another case, in which the second flow cross section of the second fluid channel section has a diameter which varies along its circumference, a minimum, an average or a maximum diameter of the second flow cross section of the second fluid channel section is to be used for the above comparisons or the above embodiments that relate to the aperture and the throttle.

A further aspect of the invention is characterized in that the fluid channel has a groove spaced apart from the flow cross section which is variable by means of the throttle flap. It is particularly preferred if the groove runs in a circumferential direction of the fluid channel, that is to say in particular orthogonally with respect to the flow direction of the fluid. It is furthermore preferred if the groove extends over the full circumference, in other words through 360° in the circumferential direction of the fluid channel. It is furthermore advantageous if the groove is formed so as to be spaced apart, in the flow direction, from the flow cross section of the first fluid channel section. It is furthermore advantageous if the first or the second fluid channel section comprises the groove. It is very particularly advantageous if the groove is formed as a transition from the first fluid channel section to the second fluid channel section. This may be realized for example by virtue of the first fluid channel section being formed separately from the second fluid channel section. It is highly preferred if the groove is formed so as to be spaced apart from the geometry of the second fluid channel section, or from the second flow cross section of the second fluid channel section, counter to the flow direction of the fluid. By means of the groove and the arrangement thereof, it is possible for swirling movements, that is to say turbulence, to be generated in the fluid flowing through the fluid channel in the case of a small opening angle of the throttle flap, in other words in the case of small flow cross sections of the first fluid channel section. This results in a further pressure drop, which necessitates a greater movement of the throttle flap for the purposes of adjusting a pressure, and thus promotes controllability.

A preferred aspect of the invention is characterized in that the second fluid channel section is formed separately from the throttle flap actuator. In other words, the throttle flap actuator can be used without the second fluid channel section. In particular, the throttle flap actuator is connected to the second fluid channel section such that the first and the second fluid channel section are connected to one another in fluid-conducting fashion, preferably directly or by means of a seal. In other words, it is possible for the second fluid channel section to be formed in modular fashion with respect to the throttle flap and/or the first fluid channel section. In other words, the second fluid channel section is formed separately from the throttle flap and/or from the first fluid channel section. In this way, it is possible for the same throttle flap actuator, that is to say the throttle flap actuator of the throttle flap actuator unit, to be arranged or used at the air inlet side in relation to a fuel cell stack, which saves further costs.

A preferred aspect of the invention is characterized in that the first and the second fluid channel section are fluid-conductively connected to one another, and in that the second fluid channel section and the throttle flap actuator or the first fluid channel section are fastened cohesively, in positively locking fashion or in non-positively locking fashion, directly or indirectly, to one another. In this way, despite the separate form of the throttle flap actuator and of the first fluid channel section, on the one hand, and of the second fluid channel section, on the other hand, an assembly or a unit is created. This fastening, in other words a connection, may be realized for example by means of a welded connection, a screw connection, a pipe clamp or a thread. Both the fluid-conducting connection and the fastening can be implemented directly or indirectly in each case independently of one another.

A preferred aspect of the invention is characterized in that the first fluid channel section is optimized in terms of flow with regard to as small a pressure drop as possible. In this way, the throttle flap actuator with the first fluid channel section, that is to say without the second fluid channel section, can be arranged or used at the air inlet side in relation to a fuel cell stack.

The second object, with regard to the provision of a fuel cell system, is achieved by a fuel cell system having a fuel cell stack and a throttle flap actuator unit according to an aspect of the invention the invention, which is arranged at the air exit side in relation to the fuel cell stack.

A preferred aspect of the invention is characterized in that a further throttle flap actuator, which is identical to the first throttle flap actuator of the throttle actuator unit, is arranged at the air inlet side in relation to the fuel cell stack. In this way, not only is it possible at the air exit side of the fuel cell system to replace the two different throttle flap actuators known from the prior art with the throttle flap actuator unit according to the invention, but it is also possible at the air inlet side to use the predominant part of the throttle flap actuator unit according to an aspect of the invention, in which the second fluid channel section and/or the geometry of the second fluid channel section is omitted. In other words, the same throttle flap actuator as that of the throttle flap actuator unit according to an aspect of the invention is provided at the air inlet side. In this way, production costs can be saved owing to the higher unit quantities, because it is now possible for the same throttle flap actuator to be used at the air inlet side and at the air outlet side. The statement that the further throttle flap actuator is identical to the first throttle flap actuator that belongs to the throttle flap actuator unit means that it is the same model, such that there is no need to produce different throttle flap actuators.

The third object, with regard to the provision of a motor vehicle, is achieved by a motor vehicle having a fuel cell system of this type. In other words, a motor vehicle is provided which comprises a fuel cell system according to one aspect of the invention. In this way, an inexpensive motor vehicle is created.

Advantageous developments of the present invention are described in the dependent claims and in the following description of the figures.

### BRIEF DESCRIPTION OF THE DRAWINGS

The invention will be discussed in more detail below on the basis of exemplary embodiments with reference to the drawings. In the drawings:

FIG. 1 is a motor vehicle having a fuel cell system and a throttle flap actuator unit;

FIG. 2A is a throttle flap actuator unit;

FIG. 2B is a sectional view of a throttle flap actuator unit; and

FIG. 3 is a flow simulation relating to a throttle flap actuator unit.

### DETAILED DESCRIPTION OF THE PRESENTLY PREFERRED EMBODIMENTS

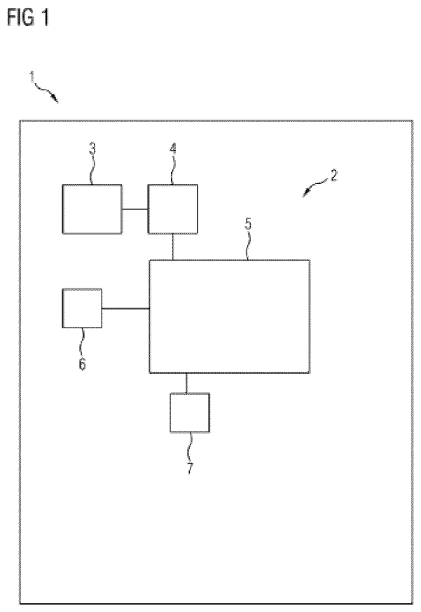

FIG. 1 shows a motor vehicle 1 that comprises a fuel cell system 2. The fuel cell system 2 has a radial compressor 3 by which an air stream can be conveyed to a fuel cell stack 5. Between the radial compressor 3 and the fuel cell stack 5, a throttle flap actuator 4 is arranged, in fluid-conducting fashion, at the air inlet side in relation to the fuel cell stack 5. The throttle flap actuator 4 corresponds to a further throttle flap actuator, which is arranged as part of a throttle flap actuator unit 7 at the air outlet side in relation to the fuel cell stack 5. The throttle flap actuator unit 7 differs from the throttle flap actuator 4 in that the throttle flap actuator unit 7 comprises, in relation to the throttle flap actuator 4, a second fluid channel section which has a geometry that gives rise to a pressure drop in a fluid that flows or can be conveyed through the fluid channel. By means of the fuel cell stack 5, it is possible for electricity to be generated which, by means of an inverter and an electric-motor drive 6, can be utilized for the propulsion of the motor vehicle 1.

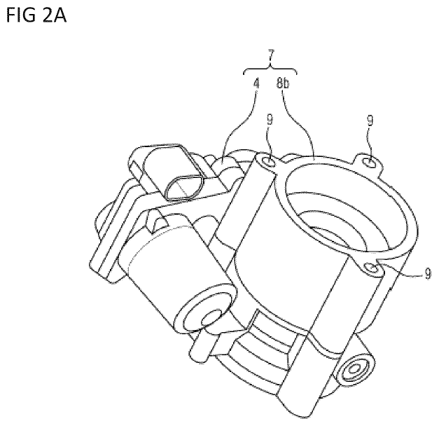

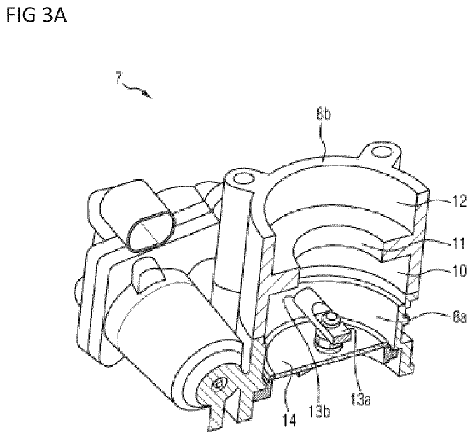

FIG. 2A shows an embodiment of the throttle flap actuator unit 7 according to one aspect of the invention, as is arranged at the air exit side in relation to the fuel cell stack in FIG. 1. The throttle flap actuator unit 7 comprises a throttle flap actuator 4 and a second fluid channel section 8b which has through bores 9, which correspond with bores in the throttle flap actuator 4, such that the first fluid channel section can be connected in fluid-conducting fashion to the second fluid channel section 8b by virtue of the second fluid channel section 8b being fastened to the throttle flap actuator 4 by means of a screw connection for which the bores 9 are provided.

Figure B shows a sectional view through the throttle flap actuator unit 7 from FIG. 2A. Here, the section runs along the flow direction of a fluid that can be conveyed through the throttle flap actuator unit 7. It is possible to see a throttle flap 14, which is adjustable by a shaft 13a from a closed position into an open position. The shaft 13a exits the first fluid channel section 8a at an exit point 13b in order to be connected in terms of drive to an electric motor of the throttle flap actuator of the throttle flap actuator unit 7. The first fluid channel section 8a is directly adjoined, in fluid-conducting fashion, by the second fluid channel section 8b. The geometry of the second fluid channel section 8b comprises a first flow cross section 10 of the second fluid channel section 8b, a second flow cross section 11 of the second fluid channel section 8b and a third flow cross section 12 of the second fluid channel section 8b, which directly follow one another in the flow direction. Here, the magnitude of the first flow cross section 10 of the second fluid channel section 8b corresponds to the third flow cross section 12 of the second fluid channel section 8b, wherein the second flow cross section 11 of the second fluid channel section 8b is smaller than the two other flow cross sections 10, 12 of the second fluid channel section 8b. Furthermore, the transitions of the individual flow cross sections 10, 11, 12 of the second fluid channel section 8b are of abrupt, in other words discontinuous, form.

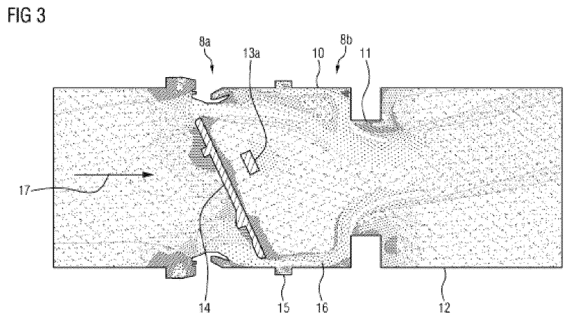

FIG. 3 shows a flow simulation of an air stream 16 in the flow direction 17 of the air stream 16 flowing through the throttle flap actuator unit. The throttle flap 14 is arranged in the first fluid channel section 8a and is situated in a position which differs only by a small angle from a closed position of the throttle flap 14. It can be seen that the shaft 13a, which is connected in terms of drive to the throttle flap 14, is situated downstream of the throttle flap 14 in the flow direction 17. Owing to the position of the throttle flap 14, the air stream 16 flows along the wall of the first fluid channel section 8a, is caused to swirl by the groove 15, and flows, in the second fluid channel section 8b, against a change in flow cross section in the form of a transition from the first to the second flow cross section 10, 11 of the second fluid channel section 8b, where an intense deflection of the air stream 16 occurs, which is associated with a corresponding pressure drop. In other words, owing to the geometry of the second fluid channel section 8b, which aside from the first flow cross section 10 also comprises a second and a third flow cross section 11, 12, the throttle flap 14 must, in order for a noticeable pressure increase to be measurable downstream of the throttle flap, for example in the third flow cross section 12 of the second fluid channel section 8b, be opened by a greater angle than would be necessary without the second fluid channel section with its geometry. It is therefore possible for the same throttle flap actuator to be used at the air inlet side and at the air outlet side in relation to a fuel cell stack, wherein the throttle flap actuator at the air outlet side is configured in the form of the throttle flap actuator unit according to the invention.

The different features of the individual exemplary embodiments can also be combined with one another.

The exemplary embodiments in FIGS. 1 to 3 are in particular not of a limiting nature and serve for illustrating the concept of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A throttle flap actuator unit comprising:
a throttle flap actuator, having a throttle flap that is electric-motor-adjustable; and
a fluid channel, the fluid channel having:
a first fluid channel section comprising a flow cross section which is variable by the throttle flap; and
a second fluid channel section, wherein the second fluid channel section has a geometry that gives rise to a pressure drop in a fluid flowing through the fluid channel.

14. The throttle flap actuator unit as claimed in claim 13, wherein the second fluid channel section is arranged spaced apart from the flow cross section of the first fluid channel section.

15. The throttle flap actuator unit as claimed in claim 13, wherein the second fluid channel section is arranged upstream or downstream of the first fluid channel section.

16. The throttle flap actuator unit as claimed in claim 13,
wherein the geometry of the second fluid channel section transitions, in a flow direction of the flowing fluid, from a first flow cross section of the second fluid channel section into a second flow cross section of the second fluid channel section, and
wherein the second flow cross section of the second fluid channel section transitions into a third flow cross section of the second fluid channel section.

17. The throttle flap actuator unit as claimed in claim 16, wherein the geometry of the second fluid channel section corresponds to a geometry of a throttle or an aperture.

18. The throttle flap actuator unit as claimed in claim 13, wherein the fluid channel has a groove spaced apart from the variable flow cross section.

19. The throttle flap actuator unit as claimed in claim 13, wherein the second fluid channel section is formed separately from the throttle flap actuator.

20. The throttle flap actuator unit as claimed claim 13,
wherein the first fluid channel section and the second fluid channel section are fluid-conductively connected to one another, and
wherein the second fluid channel section and the throttle flap actuator or the first fluid channel section are fastened cohesively, in positively locking fashion or in non-positively locking fashion to one another.

21. The throttle flap actuator unit as claimed in claim 13, wherein the first fluid channel section is optimized in terms of flow with regard to as small a pressure drop as possible.

22. A fuel cell system comprising:
a fuel cell stack; and
a first throttle flap actuator unit comprising:
a first throttle flap actuator, having a throttle flap that is electric-motor-adjustable; and
a fluid channel, the fluid channel having:
a first fluid channel section comprising a flow cross section which is variable by the throttle flap; and
a second fluid channel section, wherein the second fluid channel section has a geometry that gives rise to a pressure drop in a fluid flowing through the fluid channel,
wherein the first throttle flap actuator unit is arranged at an air outlet side in relation to the fuel cell stack.

23. The fuel cell system as claimed in claim 22, wherein
a further throttle flap actuator, which is identical to the first throttle flap actuator of the first throttle flap actuator unit, is arranged at an air inlet side in relation to the fuel cell stack.

24. A motor vehicle comprising:
a fuel cell system comprising:
a fuel cell stack; and
a throttle flap actuator unit comprising:
a throttle flap actuator, having a throttle flap that is electric-motor-adjustable; and
a fluid channel, the fluid channel having:
a first fluid channel section comprising a flow cross section which is variable by the throttle flap; and
a second fluid channel section, wherein the second fluid channel section has a geometry that gives rise to a pressure drop in a fluid flowing through the fluid channel,
wherein the throttle flap actuator unit is arranged at an air outlet side in relation to the fuel cell stack.
